(19) United States
(12) Patent Application Publication
(10) Pub. No.: US 2017/0260031 A1
(43) Pub. Date: Sep. 14, 2017

(54) Self-inflating Buoyancy Driven Elevator

(71) Applicant: Robert Hunt, Woodbury, MN (US)

(72) Inventor: Robert Hunt, Woodbury, MN (US)

(21) Appl. No.: 15/065,876

(22) Filed: Mar. 10, 2016

(51) Int. Cl. B66F 3/24; B66F 3/35

(52) U.S. Cl. CPC B66F 3/24; B66F 3/35

(57) ABSTRACT

An apparatus and process for lifting heavy objects by capturing mechanical work from the buoyant energy of liquid displacement. The apparatus comprises one or more bodies of liquid, collapsible liquid-displacement displacement vessel, and lifting force transfer means to the object, in use, the weight of the object to be lifted is secured onto the lifting platform and leveraged by the force transfer means to draw gas into the displacement vessel. Once the displacement vessel is full of gas, it will reverse the force transfer means to lift the object to the top of the liquid. Once the lifted object is secured at the elevated position, a gas release valve releases the gas and the displacement vessel collapses and sinks back down to the bottom of the liquid and the process can be repeated as necessary.

### SPECIFICATION OF THE INVENTION

The present apparatus and process are capable of delivering useable power or mechanical lifting work by generating and using a buoyancy force to drive one or more means suitable for lifting, such as a cable and pulley system, gear, pump, or shaft. The main driving forces in the apparatus is the buoyant force of a chamber of gas displacing a denser liquid at a low submerged position inside of a body of the said liquid and subsequently rising to the top of that denser liquid and producing a lifting force in the process. Specifically, the apparatus is capable of leveraging the lifting force produced by liquid displacement in order to lift heavy objects to specified heights. The heavy object itself initially serves as a force for drawing the gas into the collapsible chamber. Once the heavy object moves into position onto the lifting platform, assisted by sensors and mechanical triggers, the first movement of the lifting platform is downward as the weight of the object by mechanical means pulls on the bottom of the collapsible chamber part of the displacement vessel, drawing in gas so it inflates. Once the gas has sufficiently filled the displacement vessel, the lighter gas will cause the displacement vessel to begin its ascension through the denser liquid utilizing the power of buoyancy. The displacement vessel pulls upward on the same mechanical lifting energy transfer devise that extends outside of the body of liquid to the lifting platform. Once the displacement vessel has inflated and triggered the sensors, the lifting platform is released and the heavy object situated on the heavy platform will then begin its ascent along with the inflated displacement vessel. Once the displacement vessel reaches the top of the liquid the ascension of the heavy object is complete and it can be removed from the lifting platform, which can be secured to an upper apparatus for unloading. Once unloaded, a gas release valve is triggered and the gas escapes from the displacement vessel. The weight of the empty displacement vessel allows it to descend back down to the bottom of the body of liquid. The lifting platform simultaneously descends to its lower level in the position that is ready to receive more heavy objects so the process can be repeated.

### BRIEF DESCRIPTION OF THE SEVERAL VIEWS OF THE DRAWING

FIG. 1 is a cross section view of a basic embodiment of the apparatus in its initial state.

FIG. 2 is a cross section view of a basic embodiment of the apparatus after the heavy objects 25 have been secured onto the lifting platform 24 and lowered, drawing gas into the displacement vessel 10.

FIG. 3 is a cross section view of one embodiment of the same apparatus at a subsequent stage following FIG. 2, showing the inflated displacement vessel 10 ascending up through the liquid and lifting the heavy object in the lifting chamber 24 concurrently.

FIG. 4 is a cross section view of one embodiment of the same apparatus at a subsequent stage following FIG. 3, showing the inflated displacement vessel 10 having reached the top of the liquid.

FIG. 5 is a cross section showing only the upper section of the view of one embodiment of the same apparatus at a subsequent stage following FIG. 4, with the heavy object having made its way off of the elevated lifting platform 24 and transferred to its higher destination, and the inflated displacement vessel 10 deflating as a result of the gas escaping due to the gas release valve 12 opening, and thereby sinking back down to its lower initial position.

FIG. 6 shows an elevation view of one embodiment of the collapsible displacement vessel 10 and only the lower section of the same embodiment as in FIGS. 1-5.

### DETAILED DESCRIPTION OF THE INVENTION

With reference to the drawings, the invention will now be described with regard for the best mode and the preferred embodiment. In general, the invention is an apparatus and a process of producing mechanical work and useable lifting energy by recovering and converting liquid displacement forces into a lifting energy form. The embodiments disclosed herein are meant for illustration and not limitation of the invention. An ordinary practitioner will understand that it is possible to create many variations of the following embodiments without undue experimentation. The critical driving component of the apparatus and process is the buoyant force generated when a displacement vessel ascends and causes upward pulling energy to a transfer mechanism such as a cable and pulley system, gear, pump, piston, lever, or shaft that is secured to a lifting platform and resulting in the elevation of that lifting platform and any heavy objects that may be riding on it. The liquid can be any liquid with a viscosity suitable for ascension and descent of objects within it, and in most applications the liquid will be water or a solution of water and some other substance to make it denser. The body of liquid can be any tank, room, silo, pool, container, reservoir, or large enclosed area that can hold the necessary amount of liquid needed for adequate liquid displacement in the lifting process. The transfer mechanism can be any means of transferring the lifting energy to the lifting platform, such as a cable 30 and pulley 20 system, or other means not illustrated such as a gear, pump, piston, lever, or shaft. It can either pass through the bottom of the body of liquid through a water-tight hole 36, or it can make its way up through the inside of the body of liquid and transfer out of the top, which is not illustrated. Its course can be internally, externally, or a combination of both, through the liquid, either directly under the body of liquid, in an S curve pulley system, or by use of levers, gears, pumps or some combination of the aforementioned means that will adequately transfer the lifting force. The collapsible displacement vessel can be any compartment that can hold gas as it is submerged in the liquid which has the ability to hold sufficient quantities of gas for lifting the needed amount of weight and collapsing to hold far less to no gas. The collapsible compartment of the displacement vessel can be made of many materials suitable for collapsing depending on design, including rubber, cloth, plastic, or other alloys, membranes, and mixture of materials.

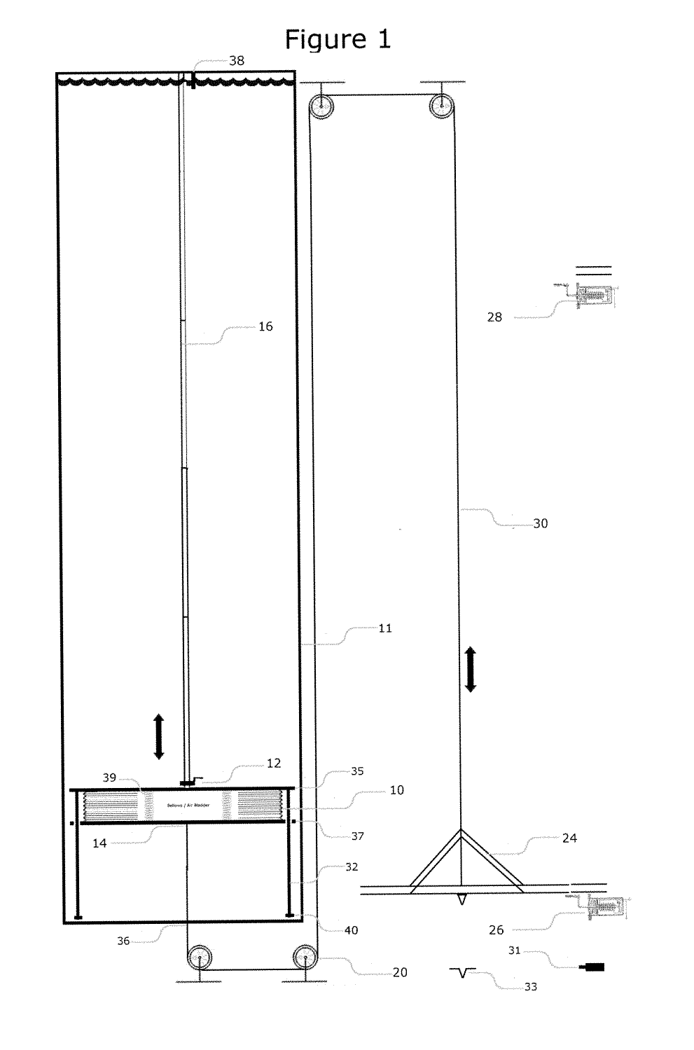

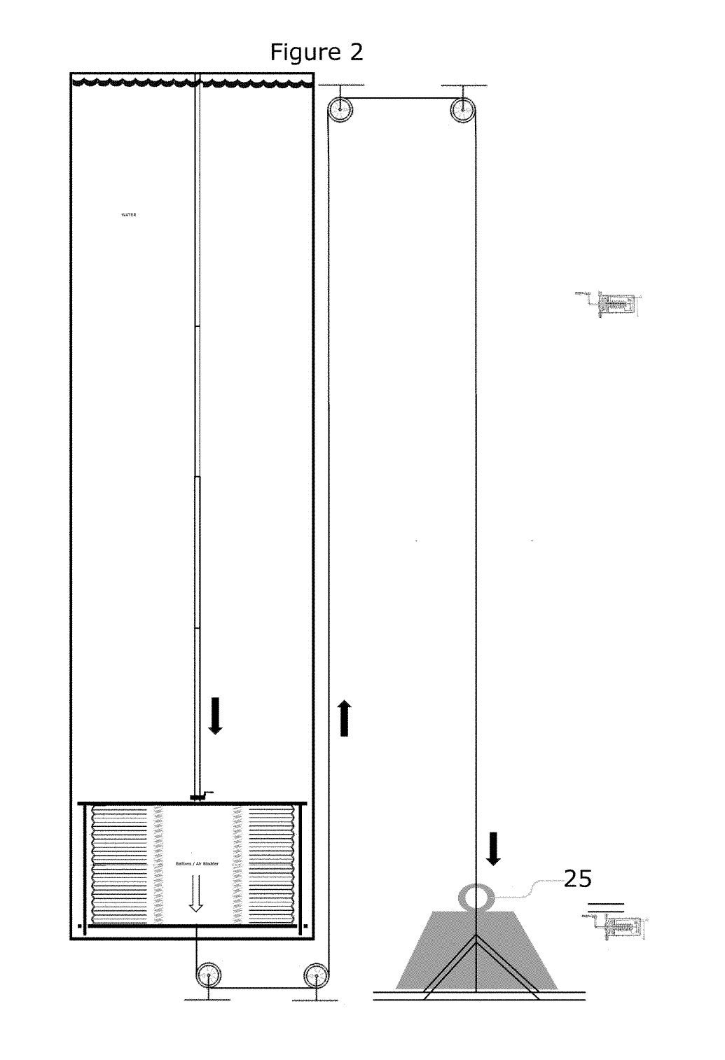

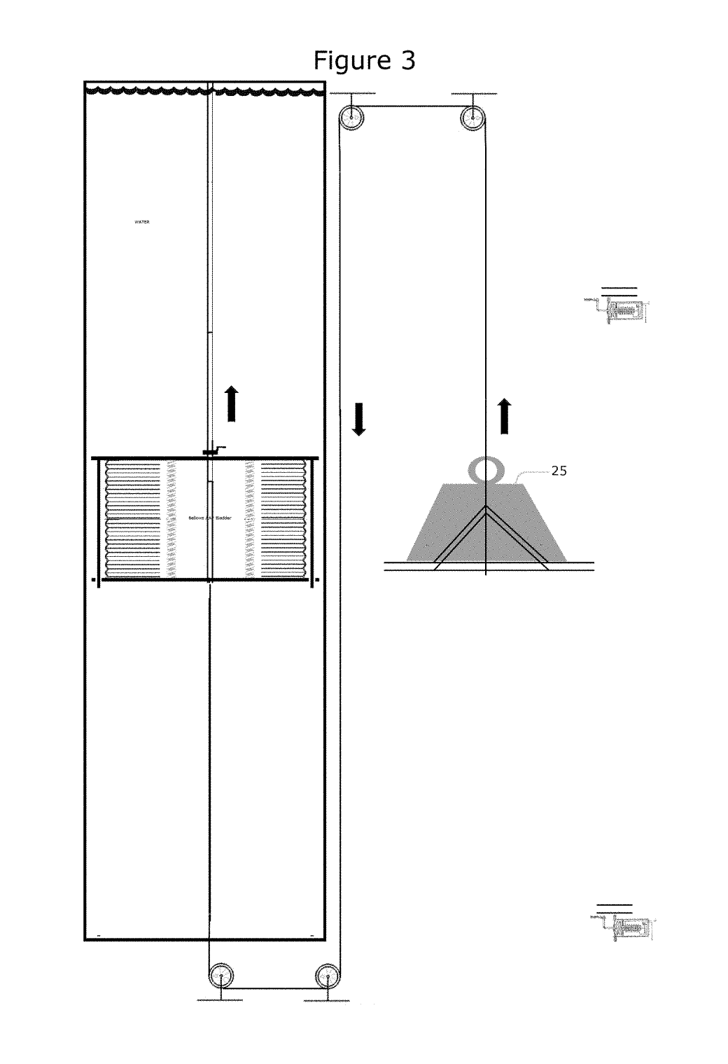

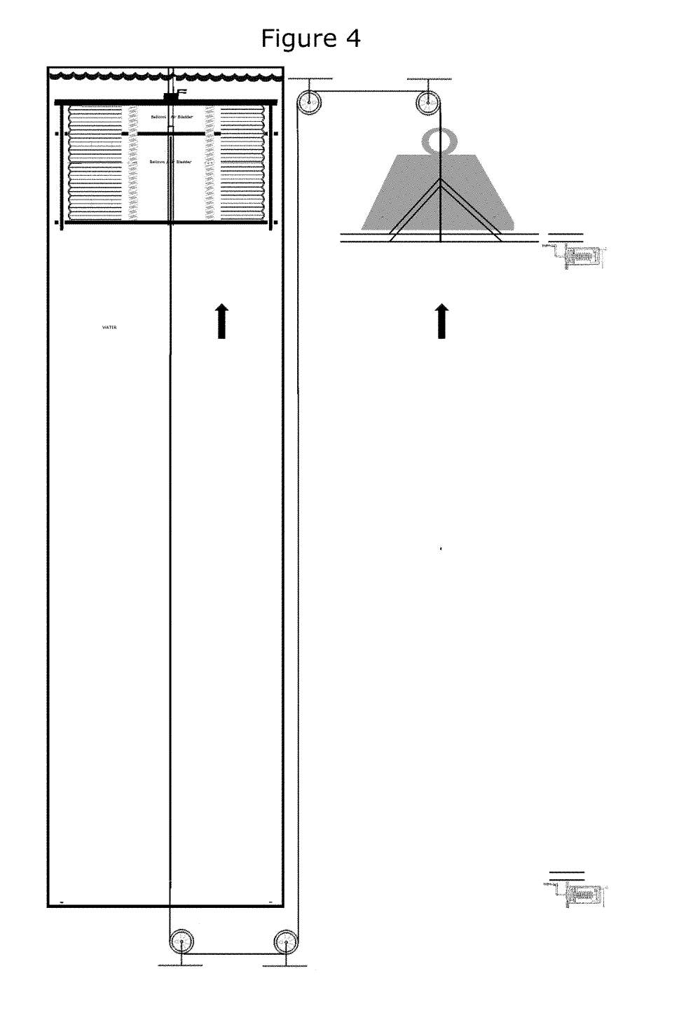

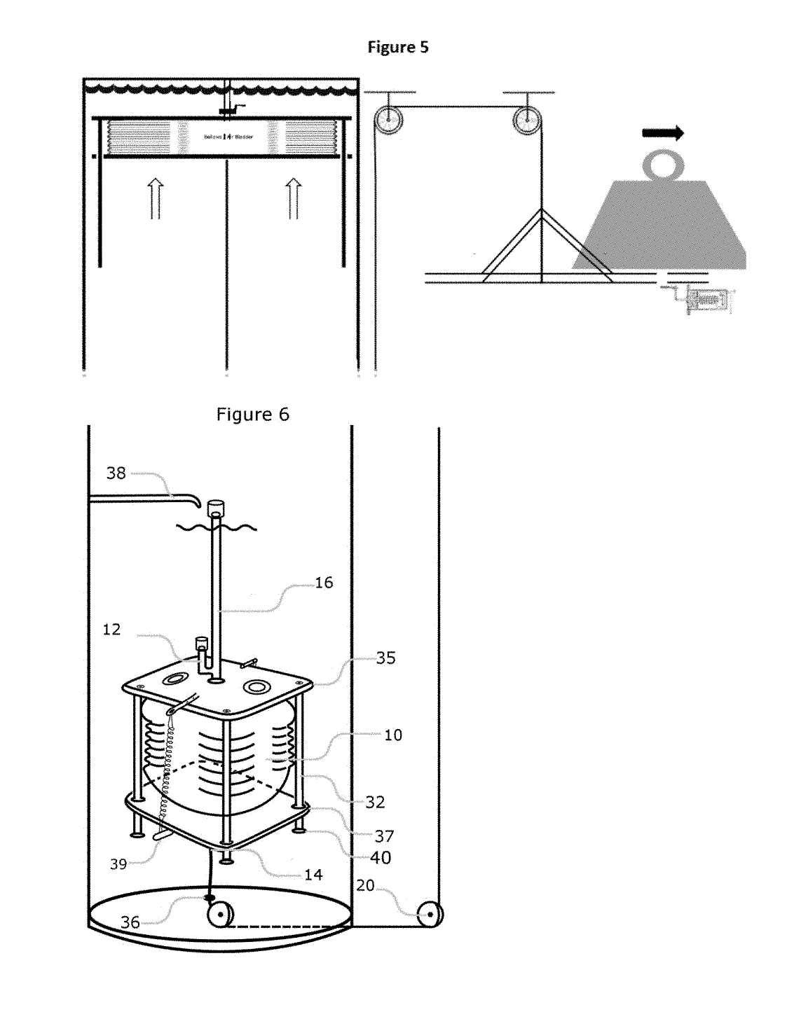

The displacement vessel apparatus is composed of an upper portion of a table-like shell or cavity mainly composed of the top platform of the apparatus 35 which has leg-like structures 32 that extend downward to rest on the floor of the body of liquid 11. The table-like shell or cavity apparatus has secured to its bottom side the top of the displacement vessel 10 and secured to its top side the gas input canal 16 and gas release valve 12. At the bottom of the displacement vessel 10 is a bottom platform 37 which is connected on its top side to the lower part of the displacement vessel 10 and on the bottom side of the lower platform center 14 it is connected to the transfer mechanism 30. Once the lifting platform 24 and displacement vessel apparatus 10 is in their initial position such as the example shown in FIG. 1, the lifting process is ready to commence. That process is as follows: When the heavy objects 25 to be lifted situates onto the lifting platform 24, a sensor and trigger 26 releases the lifting platform to move downward as fueled by gravity, pushing the lifting platform 24 downward as seen in FIG. 2. The downward moving lifting platform moves the transfer mechanism 30 in a manner that pulls the bottom of the displacement vessel's lower platform center 14 downward. The exerted pulling force to the bottom of the lower platform center 14 draws the displacement vessel 10 downward and draws gas into the displacement vessel 10 through the gas input canal 16. The bottom platform 37 slides freely down the leg-like structures 32 until it reaches the leg stoppers 40 which server to assist in structural support of the lifting apparatus as it ascends. At that point, the lifting platform latches into the stability latch 33 while the apparatus is fully inflated and becomes ready to ascend. Once the displacement vessel 10 is sensed by the sensors 31 as being full or having enough gas to lift the lifting platform 24, the lifting platform is released from its hold by the stability latch 33. The displacement vessel apparatus will then begin to ascend, causing the lifting platform 24 to ascend as well as it is pulled upward by the transfer mechanism 30. This stage in the process is shown in FIG. 3. Once the lifting platform 24 has reached the top of its elevation as shown in FIG. 4, the upper sensor and trigger 28 secures the lifting platform in place so the lifted heavy object can be transferred off of the lifting platform as shown in FIG. 5. The upper sensor and trigger 28 then senses the weight's absence and signals the release of the gas release valve 12 to be released by the gas valve releaser 38 so that the gas inside of the displacement vessel 10 can escape, allowing the displacement vessel 10 to collapse as the bottom platform 37 of the apparatus is pulled upward toward the top platform of the apparatus 35 by the retraction mechanism 39 which consists of a spring-like retraction mechanism used for collapsing the displacement vessel and pulling the bottom platform 37 back up to the top platform of the apparatus 35 and collapsing the displacement vessel 10 in between the two platforms. After all of the gas has escaped from the displacement vessel through the gas release valve 12, the now empty displacement vessel apparatus can sink back down to the bottom of the body of liquid 11 to its initial state as shown in FIG. 1 and the lifting process can begin again.

The apparatus will require periodic service and maintenance as required by the particular application and environmental conditions. More frequent service and maintenance may be required where the system operates in harsh environmental conditions, such as in liquid solutions that can be corrosive over time.

As a specific hypothetical example of a heavy object lifting embodiment which will serve as the preferred method of the embodiment, salt water is used for the liquid inside of a tank and atmospheric air will be used as the gas for the displacement vessel apparatus. There are 75,000 gallons of salt water in the tank and the displacement vessel apparatus is able to hold 15,000 gallons of air. Since one gallon of salt water weighs approximately 8 lbs., then 15,000 gallons of salt water displaced will be equal to 120,000 lbs. of buoyant force.

The equation is as follows:

15,000 gallons×8 lbs. buoyant force=120,000 lbs. of buoyant force

Based on these equations, the amount of weight-lifting buoyant force that will be supplied to the lifting mechanism will be up to 120,000 lbs. For every gallon of salt water that is displaced by the displacement vessel apparatus, there is up to 8 lbs. of lifting force that will be supplied to the mechanical transfer pulleys 20 and cables 30 or other transfer means for lifting purposes.

This is just one example of a lifting apparatus utilizing methods described above. There are numerous other embodiments, amounts, and types of liquids, gases, displacements, and leverage for the lifting mechanism. For example, the apparatus could comprise several similar lifting transfer mechanisms simultaneously, as desired. Also, multiple apparatuses could be used in combination to drive one or more energy transfer devices capable of harnessing the collective power and energy output from the multiple devices. Consequently, it is understood that equivalents and substitutions for certain elements and components set forth above are part of the invention, and therefore the true scope and definition of the invention is to be as set forth in the following claims.

1. An apparatus for lifting heavy objects utilizing energy from liquid displacement, composed of one or more of the following: (1) A large body of liquid and (2) A collapsible displacement vessel apparatus submerged within the body of liquid that is utilized for creating upward buoyant force for lifting objects, and (3) a means whereby the collapsible displacement vessel apparatus leverages the heavy objects being lifted to self-inflate.

2. The apparatus of claim #1 further comprising a collapsible displacement vessel submerged within the liquid that has the components of (a) an upper section that has legs, columns, or a support system for reaching from the bottom of the body of liquid up to the upper section. The upper section also has a gas input corral and a gas outlet valve and the upper portion of a retracting system for collapsing the displacement vessel. The upper section is also connected to the top part of the mid-section, and (b) a mid-section comprised of a gas chamber, bellows, or bladder for the purpose of inflating with gas to displace liquid and collapsing to dispel the gas, and (c) a lower section comprised of a platform or apparatus that is connected to the bottom of the mid-section and is free to move from the top down to the bottom stoppers of the legs, columns, or support system for reaching from the bottom of the body of liquid up to the upper section. The lower section also has the lower portion of a retracting system for collapsing the displacement vessel. The bottom section is also connected from the bottom side to the mechanical transfer means by which the heavy objects are lifted.

3. The apparatus of claim #2 further comprising a mechanical transfer comprising a cable and pulley system, lever, gear, pump, shaft, or line connected to the collapsible displacement vessel apparatus and able to lift or lower depending on the need, serving the purpose of either pulling the bottom of the gas chamber, bellows or bladder part of the displacement vessel apparatus in order to draw gas in to inflate it, or once inflated and floating upward, the mechanical transfer will be pulling the lifting platform.

4. The apparatus of claim #3 further comprising a lifting platform or apparatus connected to the other end of the mechanical transfer which serves the purpose of securing the heavy objects. throughout the elevation process.

5. The apparatus of claim #4 further comprising a sensor and trigger that allows for the lifting platform to initially descend in order to serve as a force to draw gas into the collapsible displacement vessel and inflate it.

6. The apparatus of claim #5 further comprising a sensor that senses when the displacement vessel is inflated to its optimal level and sub sequentially release the lifting platform to allow the submerged, inflated chamber, bellows or bladder to cause the lifting platform to ascend.

7. The apparatus of claim #5 further comprising a locking system to align and hold the lifting platform to the elevated dismount area once the lifting platform has elevated to its desired height for the purpose of allowing the heavy object being lifted to dismount from the lifting platform

8. The apparatus of claim #7 further comprising a sensor and trigger to open the gas release valve that allows the displacement vessel to expel its gas and deflate to its collapsed state

9. The apparatus of claim, #8 further comprising a retracting system that allows the displacement vessel to collapse to its gasless state in order to descend down to the bottom of the body of liquid to its initial position.

10. The apparatus of either claims 1, 2, 3, 4, 5, 6, 7, 8, or 9 in any order or combination of each other.

11. An apparatus for utilizing energy from buoyancy force for the purpose of elevating heavy objects, said apparatus comprising a large body of liquid for the purpose of that liquid being displaced to provide buoyant force; a collapsible displacement vessel submerged within the liquid that has the ability to rise when filled with gas and sink when collapsed and not filled with gas; a mechanical transfer comprising a cable and pulley system, gear, pump, shaft, or line connected to the collapsible displacement vessel; a lifting apparatus or platform connected to the opposite end of the mechanical transfer; a sensor and trigger that allows for the lifting apparatus or platform to initially descend and serve as a force to draw gas into the collapsible gas chamber, bellows or bladder part of the displacement vessel and inflate it; a sensor and release mechanism of the lifting platform to allow the inflated displacement vessel to ascend and raise the lifting platform in the process as it transfers force through the mechanical transfer means; a latch system to align and lock the lifting platform in place once it has elevated to its desired height to allow the heavy objects that have been lifted to dismount from the lifting platform; a sensor that senses when the lifting platform has been dismounted to trigger the opening of the gas release valve that allows the displacement vessel to expel its gas and collapse; a retracting system that allows the gas chamber, bellows or bladder part of the displacement vessel to collapse to its gasless state in order to descend dawn to the bottom of the body of liquid to its initial state so that the lifting cycle can start again.

12. A process or method for lifting objects whereby energy from buoyant force is utilized for the purpose of elevating heavy objects, said apparatus comprising one or more of the following: a large body of liquid, chamber, silo, compartment or pool containing: liquid for the: purpose of that liquid being displaced to provide buoyant force; a collapsible displacement vessel submerged within the liquid that has the ability to rise when filled with gas and sink when collapsed and not filled with gas; a mechanical transfer comprising a cable and pulley system, gear, pump, shaft, or line connected to the collapsible gas chamber, bellows or bladder part of the displacement vessel; a lifting apparatus or platform connected to an end of the mechanical transfer that is opposite of the collapsible displacement vessel; a sensor and trigger that allows for the lifting apparatus or platform to initially descend after heavy objects have been placed onto the lifting platform and serve as a force to draw gas into the collapsible gas chamber, bellows or bladder of the displacement vessel to inflate it; a sensor and release mechanism of the lifting platform to allow the inflated displacement vessel to ascend and raise the lifting platform in the process as it transfers force through the mechanical transfer means; a locking system to lock the lifting platform in place once it has elevated to its desired height to allow the heavy objects that have been lifted to dismount from the lifting platform; a sensor that senses when the lifting platform has been dismounted to trigger the opening of the gas release valve that allows the displacement vessel to expel its gas and collapse; a retracting system that allows the gas chamber, bellows or bladder part of the displacement vessel to collapse to its gasless state in order to allow the displacement vessel to descend down to the bottom of the body of liquid to its initial state so that the lifting cycle can start again.
